(19) United States
(12) Patent Application Publication
(10) Pub. No.: US 2021/0009828 A1
(43) Pub. Date: Jan. 14, 2021

(54) WATER-BASED INK FOR INK-JET RECORDING AND INK SET

(71) Applicant: BROTHER KOGYO KABUSHIKI KAISHA, Nagoya-shi (JP)

(72) Inventors: Mitsunori MAEDA, Nagoya-shi (JP); Yuka TSUZAKA, Nagoya-shi (JP); Keisuke YUHARA, Nagoya-shi (JP)

(73) Assignee: BROTHER KOGYO KABUSHIKI KAISHA, Nagoya-shi, (JP)

(21) Appl. No.: 16/925,362

(22) Filed: Jul. 10, 2020

(30) Foreign Application Priority Data
Jul. 12, 2019 (JP) 2019-130461

(51) Int. Cl. C09D 11/322; C09D 11/40; C09D 11/033; C09D 11/037

(52) U.S. Cl. CPC C09D 11/322; C09D 11/037; C09D 11/033; C09D 11/40

(57) ABSTRACT

A water-based ink for ink-jet recording, includes: a solid solution of a quinacridone pigment including C.I. Pigment Violet 19 and C.I. Pigment Red 202, an azo pigment including C.I. Pigment Red 150, and water.

### CROSS REFERENCE TO RERATED APPLICATION

The present application claims priority from Japanese Patent Application No. 2019-130461 filed on Jul. 12, 2019, the disclosure of which is incorporated herein by reference in its entirety.

### BACKGROUND OF THE INVENTION

### Field of the Invention:

The present disclosure is related to a water-based ink for ink-jet recording and an ink set.

### Description of the Related Art:

There is well known for improving ink characteristics by using two kinds of pigments in ink (see, for example, Patent Literature 1: Japanese Patent Application Laid-open Publication No. 2018-150515 corresponding to United States Patent Application Publication No. US2018/0258302).

In view of visibility, a red-based color is important in ink-jet recording. Thus, a color gamut from magenta to red is required to be widened so that color reproducibility on a recording medium is widened. When the color reproducibility is achieved by a red ink not using three primary colors of yellow, magenta, and cyan, the color balance is affected thereby. Thus, it is important to improve the magenta ink that is one of the three primary colors.

However, there is no water-based ink for ink-jet recording in which a recording density is high and chromaticness from magenta to red (a color gamut in an a*-b* planar direction) is wide.

In view of the above, an object of the present disclosure is to provide a water-based ink for ink-jet recording in which a recording density is high (namely, an optical density is high) and chromaticness from magenta to red (a color gamut in an a*-b* planar direction) is wide.

### SUMMARY OF THE INVENTION

According to a first aspect of the present disclosure, there is provided a water-based ink for ink-jet recording, including: a solid solution of a quinacridone pigment including C.I. Pigment Violet 19 and C.I. Pigment Red 202, an azo pigment including C.I. Pigment Red 150, and water.

According to a second aspect of the present disclosure, there is provided an ink set including: a water-based magenta ink for ink-jet recording that is the water-based ink for ink-jet recording described in the first aspect; and a water-based yellow ink for ink-jet recording that contains a yellow pigment and water.

### BRIEF DESCRIPTION OF THE DRAWINGS

FIG. 1 is a graph explaining a synergetic effect of the present disclosure, wherein optical densities of Example 2, Example 4, Comparative Example 1, and Comparative Example 2.

FIG. 2 is a schematic perspective view of an exemplary configuration of an ink-jet recording apparatus according to the present disclosure.

### DESCRIPTION OF THE PREFERRED EMBODIMENT

In the present disclosure, a chromaticness (C*) is calculated, for example, by^{,} the following formula using a* and b* based on an L*a*b* color system (CIE 1976 (L*a*b*) color system) normalized or standardized by Commission Internationale d'Eclairage (CIE) in 1976 (see, JIS Z 8729).

C*={(a*²)+(b*²)}^{1,2}

In the present disclosure, a hue angle means, for example, an angle in accordance with an L*a*b* color system chromaticity diagram (a*-b* plane) in which a* and b* are represented on a plane. The hue angle is defined as follows:
when satisfying a*≥0 and b*≥0 (the first quadrant), the hue angle is tan⁻¹(b*/a*);
when satisfying a*≤0 and b*≥0 (the second quadrant), the hue angle is 180° +tan⁻¹ (b*/a*);
when satisfying a*≤0 and b*≤0 (the third quadrant), the hue angle is 180° +tan⁻¹ (b*/a*); and
when satisfying a*≥0 and b*≤0 (the fourth quadrant), the hue angle is 360° +tan⁻¹ (b*/a*).

A water-based ink for ink-jet recording of the present disclosure (hereinafter referred to as “water-based ink” or “ink” in some cases) is explained. The water-based ink of the present disclosure contains a quinacridone pigment, an azo pigment, and water.

The quinacridone pigment contains a solid solution that contains C.I. Pigment Violet 19 (hereinafter referred to as “PV19” in some cases) and C.I. Pigment Red 202 (hereinafter referred to as “PR202” in some cases). In the present disclosure, the “solid solution” indicates a pigment existing as a mixed crystal (a crystallized state of two or more kinds of pigment molecules in a mixed state) of two or more kinds of pigment molecules, and is different from one obtained by simply mixing two or more kinds of pigments. The solid solution may be a quinacridone pigment that contains at least PV19 and PR202. The solid solution may or may not contain a quinacridone pigment different from PV19 and PR202 (hereinafter referred to as “any other pigment”). When the solid solution contains any other pigment described above, a ratio of a content of any other pigment described above in an entire amount of the solid solution is, for example, smaller than a content of the solid solution in an entire amount of the water-based ink and a content of C.I. Pigment Red 150 in the entire amount of the water-based ink. The ratio of the content of any other pigment described above in the entire amount of the solid solution is, for example, less than 0.3% by mass, not more than 0.1% by mass, or 0% by mass. The solid solution containing PV19 and PR202 may be any commercially available product, or may be produced by a publicly known producing method.

The content (_{Q}) of the quinacri done pigment in the entire amount of the water-based ink is, for example, 2 to 10% by mass, 4 to 8.5% by mass, 5 to 8% by mass, or 5 to 7% by mass.

Only the solid solution that contains PV19 and PR202 may be used as the quinacridone pigment in the water-based ink. Further, the water-based ink may contain not only the solid solution that contains PV19 and PR202 but also a quinacridone pigment different from the solid solution that contains PV19 and PR202. In the water-based ink, the mass ratio of the solid solution that contains PV19 and PR202 in the entire amount of the quinacridone pigment is, for example, not less than 50% by mass, not less than 70% by mass, or 100% by mass.

The azo pigment contains C.I. Pigment Red 150 (hereinafter referred to as “PR150” in some cases), C.I. Pigment Red 150 does not form solid solution with any other pigment, namely, C.I. Pigment Red 150 is a non-solid solution pigment dispersed in the water-based ink.

The content (A) of the azo pigment in the entire amount of the water-based ink is, for example, 0.1 to 5% by mass, 0.2 to 4% by mass, or 0.5 to 3% by mass.

Only the PR150 may be used as the azo pigment in the water-based ink. Further, the water-based ink may contain not only PR150 but also any other azo pigment than PR150. In the water-based ink, the mass ratio of PR150 in the entire amount of the azo pigment is, for example, not less than 50% by mass, not less than 70% by mass, or 100% by mass.

Since PR150 and the solid solution that contains PV19 and. PR202 are used together in the water-based ink, a recording density is high and a chromaticness from magenta to red (a color gamut in an a*-b* planar direction) is wide in the water-based ink.

The chromaticness from magenta to red (the color gamut in the a*-b* planar direction) is wide in the water-based ink of the present disclosure, In other word, a color (chromaticity) of an image formed using the water-based ink of the present disclosure is plotted at a position where the chromaticness is high (a position away from the origin) in an area from magenta to red (hue angle approximately −40° to approximately 40° in an a*-b* plane. This means the water-based ink of the present disclosure can achieve the wide color reproduction gamut from magenta to red.

A mass ratio between the content (Q) of the quinacridone pigment and the content (A) of the azo pigment in the entire amount of the water-based ink is, for example, Q:A=95:5 to 40:60, 90:10 to 50:50, 90:10 to 60:40, or 80:20 to 60:40.

A total (Q+A) of the content (Q) of the quinacridone pigment and the content (A) of the azo pigment in the entire amount of the water-based ink is, for example, 4 to 8% by mass, 4.5 to 8% by mass, 5 to 8% by mass, or 6 to 8% by mass.

When the mass ratio satisfies Q:A=90:10 to 50:50 and the total (Q+A) satisfies 4.5 to 8% by mass, it is possible to obtain the water-based ink in which a balance between the magenta chromaticness and the red chromaticness is good and the recording density is good.

When the mass ratio satisfies Q:A=80:20 to 60:40 and the total (Q+A) satisfies 5 to 8% by mass, it is possible to obtain the water-based ink in which the total of the magenta chromaticness and the red chromaticness is good.

When the mass ratio satisfies Q:A=80:20 to 60:40 and the total (Q+A) satisfies 6 to 8% by mass, it is possible to obtain the water-based ink in which the recording density is good.

The water-based ink may or may not contain not only the quinacridone pigment and the azo pigment but also any other pigment than the quinacridone pigment and the azo pigment, dye, and the like.

Pigments that may be used in the water-based ink, including the quinacridone pigment and the azo pigment, are exemplified, for example, by CI Pigment Reds 2, 3, 5, 6, 7, 12, 15, 16, 48, 48:1, 53:1, 57, 57:1, 112, 122, 123, 139, 144, 146, 149, 150, 166, 168, 175, 176, 177, 178, 184, 185, 190, 202, 221, 222, 224, and 238; C.I. Pigment Violets 19 and 196. Among those, the quinacridone pigment and the azo pigment are preferably used.

The water-based ink may be prepared by dispersing the pigment in water with a dispersant. As the dispersant, it is allowable to use, for example, a general-purpose polymeric dispersant (resin for dispersing pigment, pigment-dispersing resin), etc. The pigment may be a self-dispersible pigment. The self-dispersible pigment is dispersible in water without using any dispersant, for example, owing to the fact that at least one of a hydrophilic group and the salt thereof including, for example, carbonyl group, hydroxyl group, carboxylic acid group, sulfonic acid group (sulfonate group), phosphoric acid group (phosphate group), etc. is introduced into the surfaces of the particles of the self-dispersible pigment by the chemical bond directly or with any group intervening therebetween.

The water is preferably ion-exchange water or purified water (pure water). The content of the water in the entire amount of the water-based ink is, for example, 10 to 90% by mass, or 20 to 80% by mass. The content of the water also may be, for example, a balance of the other components.

The water-based ink may contain an acetylenic glycol-based surfactant. The acetylenic glycol-based surfactant is exemplified, for example, by a compound represented by the formula (1):

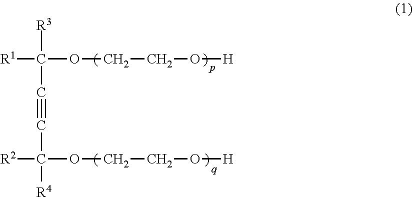

In the formula (1), p and q may be identical to each other or different from each other. For example, p and q are integers satisfying p+q=1 to 15, 3 to 11, or 4 to 10. In the formula (1), R¹, R², R³, and R⁴ may be identical to each other or different from each other, and each of R¹, R², R³, and R⁴ is a straight or branched chain alkyl group having 1 to 5 carbon atoms.

A commercially available product may be used as the acetylenic glycol-based surfactant. Examples of the commercially available product include “Surfynol (trade name) 440”, “Surfynol (trade name) 465”, and “Surfynol (trade name) 485” produced by Air Products and Chemicals, “OLIFIN (trade name) E1004”, “OLFIN (trade name) E1008”, and “OLEIN (trade name) E1010” produced by Nissin Chemical Industry Co., Ltd; and “ACETYLENOL (trade name) E40” and “ACETYLENOL (trade name) E 100 ” produced by Kawaken Fine Chemicals Co., Ltd.

For example, the ratio of the content of the acetylenic glycol-based surfactant to a total of 100 parts by mass of the content of the quina.cridone pigment and the content of the azo pigment is not less than 4 parts by mass, or 5 to 10 parts by mass. By making the ratio of the content of the acetylenic glycol-based surfactant within the above range, ink droplets are appropriately wet and spread on the surface of the recording medium, and thus an image quality is expected to be improved.

The water-based ink may further contain any other surfactant than the acetylenic glycol-based surfactant. In view of the solubility of the acetylenic glycol-based surfactant, the acetylenic glycol-based surfactant is preferably used with any other surfactant described above. Examples of any other surfactant described above include: nonionic surfactants produced by KAO CORPORATION, including “EMULGEN (trade name)” series, “RHEODOL (trade name)” series, “EMASOL (trade name)” series, “EXCEL (trade name)” series, “EMANON (trade name)” series, “AMIET (trade name)” series, “AMMON (trade name)” series; nonionic surfactants produced by TOHO CHEMICAL INDUSTRY CO., LTD., including “SOLVON (trade name)” series; nonionic surfactants produced by Lion Corporation, including “DOBANOX (trade name)” series, “LEOCOL (trade name)” series, “LEOX (trade name)” series, “LAOL, LEOCON (trade name)” series, “LIONOL (trade name)” series, “CADENAX (trade name)” series, “LIONON (trade name)” series, “LEOFAT (trade name)” series; anionic surfactants produced by KAO CORPORATION including “EMAL (trade name)” series, “LATEMUL (trade name)” series, “VENOL (trade name)” series, “NEOPELEX (trade name)” series, NS SOAP, KS SOAP, OS SOAP, and “PELEX (trade name)” series; and anionic surfactants produced by Lion Corporation, including “LIPOLAN (trade name)” series, “LIPON (trade name)” series, “SUNNOL (trade name)” series, “LIPOTAC (trade name)” series, “ENAGICOL (trade name)” series, “LIPAL (trade name)” series, and “LOTAT (trade name)” series; and cationic surfactants produced by Dai-Ichi Kogyo Seiyaku Co., Ltd including “KACIHOGEN (trade name) ES-OW” and “KACHIOGEN (trade name) ES-L”. Examples of any other surfactant described above may be used alone or in a combination of two or more thereof.

The water-based ink may further contain a water-soluble organic solvent. The water-soluble organic solvent is exemplified, for example, by a humectant that inhibits ink from drying at an end of a nozzle in an ink-jet head and a penetrant that adjusts, for example, the dry speed of the water-based ink on a recording medium.

Examples of the humectant include, but not limited to, lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyethers such as polyalkylene glycol; polyvalent alcohols such as alkylene glycol, glycerol, trimethylolpropane, and trimethylolethane; 2-pyrrolidone; N-methyl-2-pyrrolidone; and 1,3-dimethyl-2-imidazolidinone. The polyalkylene glycol is exemplified, for example, by polyethylene glycol and polypropylene glycol. The alkylene glycol is exemplified, for example, by ethylene glycol, propylene glycol, butylene glycol, diethylene glycol, triethylene glycol, &propylene glycol, tripropylene glycol, thiodiglycol, and hexylene glycol. Those may be used alone or in a combination of two or more thereof. Among them, polyvalent alcohol(s) such as alkylene glycol and glycerol is/are preferably used.

The content of the humectant(s) in the entire amount of the water-based ink is, for example, 0 to 95% by mass, 5 to 80% by mass, or 5 to 50% by mass.

An example of the penetrant is glycol ether. Examples of the glycol ether include ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, trimethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. Those may be used alone or in a combination of two or more thereof.

The content of the penetrant(s) in the entire amount of the water-based ink is, for example, 0 to 20% by mass, 0 to 15% by mass, or 1 to 6% by mass.

The water-based ink may further contain a conventionally known additive, as necessary. The additive is exemplified, for example, by pH-adjusting agents, viscosity-adjusting agents, surface tension-adjusting agents, fungicides, and fixing agents for gloss paper. The viscosity-adjusting agents are exemplified, for example, by polyvinyl alcohol, cellulose, water-soluble resins, and the like.

The water-based ink can be prepared, for example, by uniformly mixing, for example, the quinacridone pigment, the azo pigment, the water, and an optionally other additive(s) as necessary, by a conventionally known method, and then removing any non-dissolved matter, with a filter or the like.

As described above, the water-based ink for ink-jet recording of the present disclosure includes both C.I. Pigment Red 150 and the solid solution that contains C.I. Pigment Violet 19 and C.I. Pigment Red 202. Thus, its chromaticness from magenta to red (a color gamut in an a*-b* planar direction) is wide and its recording density is high (namely, the optical density is high).

Next, an ink set of the present disclosure is explained.

The ink set of the present disclosure includes a water-based magenta ink for ink-jet recording and a water-based yellow ink for ink-jet recording. The water-based magenta ink is the water-based ink for ink-jet recording of the present disclosure. The water-based yellow ink contains a yellow pigment and water.

Examples of the yellow pigment include C.I. Pigment Yellows 1, 2, 3, 12, 13, 14, 15, 16, 17, 55, 73, 74, 75, 78, 83, 93, 94, 95. 97, 98, 114, 128, 129, 138, 150, 151, 154, 180, 185, and 194; and solid solutions of the above-described pigments. Those may be used alone or in a combination of two or more thereof. Among them, C.I. Pigment Yellow 74 is preferably used in view of improving the red chromaticness.

In the water-based yellow ink, the water is preferably ion-exchange water or purified water (pure water). The content of the water in the entire amount of the water-based yellow ink may be, for example, 10 to 90% by mass, or 20 to 80% by mass. The content of the water may be, for example, a balance of the other components.

The water-based yellow ink may further contain the surfactant, water-soluble organic solvent, additive, and the like that are similar to the water-based ink containing the quinacridone pigment and the azo pigment according to the present disclosure, as needed.

The water-based yellow ink can be prepared, for example, by uniformly mixing, for example, the yellow pigment, the water, and an optionally other additive(s) as necessary, by a conventionally known method, and then removing any non-dissolved matter, with a filter or the like.

The ink set of the present disclosure may satisfy the following conditional expression. The ink set of the present disclosure satisfying the following conditional expression has a good red chromaticness.

Y≤(Q+A)+2
Y: A content (% by mass) of the yellow pigment in the entire amount of the water-based yellow ink
Q+A: A total (% by mass) of the content (Q) of the quinacridone pigment and the content (A) of the azo pigment in an entire amount of the water-based magenta ink

Subsequently, an inkjet recording apparatus of the present disclosure is explained.

The ink-jet recording apparatus of the present disclosure is an ink-jet recording apparatus including: an ink accommodating section and an ink jetting mechanism. Ink is accommodated in the ink accommodating section and the ink accommodated in the ink accommodating section is jetted by the ink jetting mechanism. The water-based ink for ink-jet recording of the present disclosure is accommodated in the ink accommodating section.

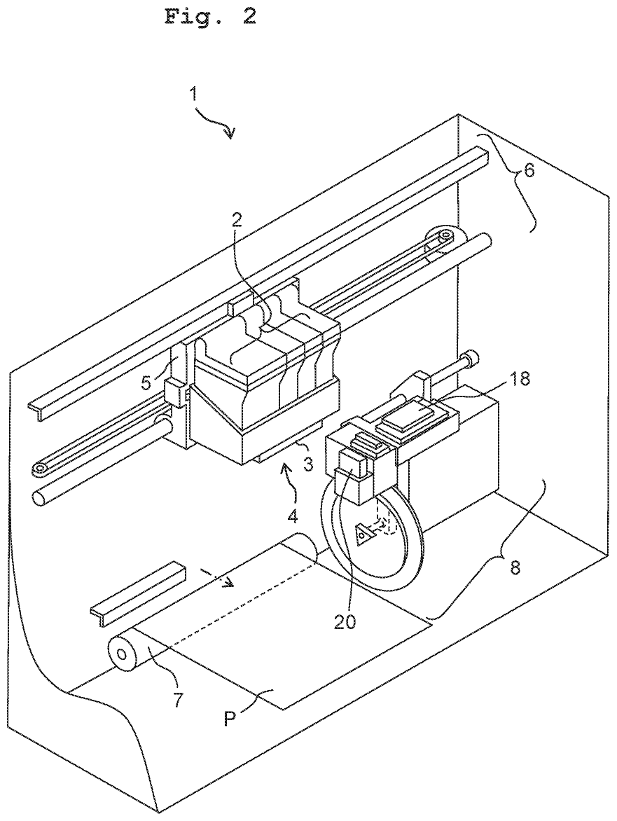

FIG. 2 depicts an exemplary configuration of the ink-jet recording apparatus of the present disclosure. As depicted in FIG. 2, an ink-jet recording apparatus 1 includes four ink cartridges 2, an ink jetting mechanism (ink-jet head) 3, a head unit 4, a carriage 5, a driving unit 6, a platen roller 7 and a purge device 8 as main constitutive components or parts of the ink-jet recording apparatus 1.

Each of the four ink cartridges 2 contains one of four water-based inks of yellow, magenta, cyan, and black. For example, the water-based magenta ink is the water-based ink for ink-jet recording of the present disclosure. For example, the water-based yellow ink is the water-based yellow ink for ink-jet recording included in the ink set according to the present disclosure. In this example, a set with the four ink cartridges 2 is explained. However, instead of this set, the present disclosure may use an integrated type ink cartridge of which interior is comparted (partitioned) to form a water-based yellow ink accommodating section, a water-based magenta ink accommodating section, a water-based cyan ink accommodating section, and a water-based black ink accommodating section. As a body of the ink cartridge, for example, any conventionally known main body of an ink cartridge may be used.

The ink-jet head 3 disposed on the head unit 4 performs recording on a recording medium P (e.g., recording paper). The four ink cartridges 2 and the head unit 4 are provided or arranged on the carriage 5. The driving unit 6 causes the carriage 5 to reciprocate in a linear direction. As the driving unit 6, it is possible to use, for example, a conventionally known driving unit (see, for example, Japanese Patent Application laid-open No. 2008-246821 corresponding to United States Patent Application Publication No. US2008/0241398 A1). The platen roller 7 extends in the reciprocating direction of the carriage 5 and is arranged to face the ink-jet head 3.

The purge device 8 sucks or draws unsatisfactory ink (poor ink) which contains air bubbles, etc., accumulated or trapped in the inside of the ink-jet head 3. As the purge device 8, it is possible to use, for example, a conventionally known purge device (for example, see Japanese Patent Application laid-open No. 2008-246821 corresponding to United States Patent Application Publication No. US2008/0241398 A1).

A wiper member 20 is provided on the purge device 8 at a position on the side of the platen roller 7 such that the wiper member 20 is adjacent to the purge device 8. The wiper member 20 has a spatula shape, and wipes a nozzle-formed surface of the ink-jet head 3 accompanying with the movement (reciprocating movement) of the carriage 5. In FIG. 2, a cap 18 is provided to cover nozzles of the ink-jet head 3 that is returned to a reset position upon completion of recording, so as to inhibit the water-based inks from drying.

In the ink-jet recording apparatus 1 of this example, the four ink cartridges 2 are provided, together with the head unit 4, on one carriage 5. The present disclosure, however, is not limited thereto. In the ink-jet recording apparatus 1, the four respective ink cartridges 2 may be provided on a carriage which is different (separate) from the carriage on which the head unit 4 is provided. Alternatively, the four respective ink cartridges 2 may be arranged and fixed inside the ink-jet recording apparatus 1, rather than being provided on the carriage 5. In such aspects, for example, the four ink cartridges 2 are connected to the head unit 4 provided on the carriage 5 via tubes, etc., and the water-based inks are supplied from the four ink cartridges 2, respectively, to the head unit 4. Further, in these aspects, it is allowable to use four ink bottles having a bottle shape instead of using the four ink cartridges 2. In such a case, each of the ink bottles is preferably provided with an inlet port via which the ink is poured from the outside to the inside of each of the ink bottles.

Ink-jet recording using the ink-jet recording apparatus 1 is performed, for example, as follows. At first, the recording paper P is supplied or fed from a paper feeding cassette or paper feeding cassette (not depicted in the drawing) arranged at a side of or at a position below the ink-jet recording apparatus 1. The recording paper P is introduced or guided between the ink-jet head 3 and the platen roller 7. Then, predefined recording is performed on the fed or introduced recording paper P with the water-based ink(s) jetted from the ink-jet head 3. The recording paper P after recording is discharged from the ink-jet recording apparatus 1. According to the present disclosure, it is possible to obtain a recording object in which the recording density is high and the chromaticness from magenta to red (the color gamut in the a*-b* planar direction) is wide. In FIG. 2, illustration of the feed mechanism and discharge mechanism for the recording paper P is omitted.

in the apparatus depicted in FIG. 2, a serial type ink-jet head is adopted. The present disclosure, however, is not limited to this. The ink-jet recording apparatus may be an apparatus adopting a line type inkjet head.

### EXAMPLES

Next, examples of the present disclosure are explained together with comparative examples. The present disclosure is not limited and is not restricted to the examples and the comparative examples described below.

### Preparation of Pigment Dispersion Liquids A and B

Purified water was added to 20% by mass of a pigment (solid solution of PV19 and PR202) and 7% by mass of a sodium hydroxide neutralized product of a styrene-acrylic acid copolymer (acid value 175 mgKOH/g, molecular weight 10,000), so that the sum of them was 100% by mass, followed by being stirred (agitated) and mixed with each other. This mixture was put in a wet sand mill using zirconia beads with a diameter of 0.3 mm as a medium to perform dispersion treatment for six hours. After that, the zirconia beads were removed by a separator, and the mixture obtained was filtrated through a cellulose acetate filter (pore size 3.00 μm). A pigment dispersion liquid A indicated in Table 1 was thus obtained. The styrene-acrylic acid copolymer was a water-soluble polymer that was generally used as the resin dispersant of the pigment. A pigment dispersion liquid B indicated in Table 1 was obtained in a similar manner as the pigment dispersion liquid A, except that the type of pigment, the ratio of components, and the dispersion treatment time were changed appropriately.

### Examples 1 to 12 and Comparative Examples 1 and 2

Components included in the ink composition (Table 1), except for the pigment dispersion liquids A and B, were mixed uniformly or homogeneously; and thus an ink solvent was obtained. Subsequently, the ink solvent was added to each of the pigment dispersion liquids A and B, followed by being mixed uniformly, and thus a mixture was obtained. After that, the mixture obtained was filtrated through a cellulose acetate membrane filter (pore size 3.00 μm) manufactured by TOYO ROSHI KAISHA, LTD., and thus the water-based ink for ink_{—} jet recording in each of Examples 1 to 12 and Comparative Examples 1 and 2 indicated in Table 1 was obtained.

With respect to the water-based inks of Examples 1 to 12 and Comparative example 1 and 2, (a) evaluation for magenta chromaticness, (b) evaluation for red chromaticness, (c) total evaluation of the magenta chromaticness and the red chromaticness, and (d) evaluation for recording density were performed by the following methods.

### (a) Evaluation for Magenta Chromaticness

An ink-jet recording apparatus “MFC-J6995CDW” manufactured by BROTHER KOGYO KABUSHIKI KAISHA was used to record an image at 100% recording duty on a recording medium (“Hammermill Fore Multi-Purpose Paper” manufactured by International Paper) by using the water-based ink in each of the examples and comparative examples. The chromaticness (C*) was measured at five portions in the image by using a spectrophotometer (spectrophotornetric colorimetry meter) SpectroEye produced by X-Rite, an average value thereof was obtained, and the magenta chromaticness was evaluated in accordance with the following evaluation criteria. Here, the magenta chromaticness means a chromaticness (C*) of the magenta color (hue angle: −40° to 0° . In the present disclosure, the “recording duty” is defined, for example, by the following equation.

Recording duty (%)=real recording dot number/(longitudinal resolution×lateral resolution)×100
Real recording dot number: real recording dot number per unit area;
Longitudinal resolution: longitudinal resolution per unit area;
Lateral resolution: lateral resolution per unit area.

### Evaluation Criteria for Magenta Chromaticness Evaluation

AA: Chromaticness (C*) was not less than 64;
A: Chromaticness (C*) was not less than 62 and less than 64;
B: Chromaticness (C*) was not less than 60 and less than 62;
C: Chromaticness (C*) was less than 60;
NG: Magenta color was not able to be produced or made. Namely, the hue angle of the recording image was not in the range of −40° to 0°.

### (a) Evaluation for Red Chromaticness

The ink set was formed by combining the water-based ink (water-based magenta ink) in each of the examples and comparative examples and a water-based yellow ink having the following composition. The ink-jet recording apparatus “MFC-J6995CDW” was used to record images at 120% recording duty on the recording medium (“Hammermill Fore Multi-Purpose Paper”) by using the ink set in each of the examples and comparative examples while the ratio of the dot number of the water-based magenta ink (MD) to the dot number of the water-based yellow ink (YD) was changed from MD:YD=100:0 to MD:YD=0:100 at 5% intervals. Among the images, an image of which hue angle was closest to 25° was used as an evaluation sample. The Chromaticness (C*) was measured at five portions in the evaluation sample by using the spectrophotometer SpectroEye, an average value thereof was determined, and the red chromaticness was evaluated in accordance with the following evaluation criteria. A pigment dispersion liquid C in the following water-based yellow ink composition was prepared in a similar manner as the pigment dispersion liquid A, except that the type of pigment, the ratio of components, and the dispersion treatment time were changed appropriately.

### Water-based Yellow Ink Composition

| | |
|---|---|
| Pigment Dispersion Liquid C (*1) | 6% by mass (solid content |
| | amount of pigment) |
| glycerol | 8% by mass |
| polyethylene glycol #200 | 3% by mass |
| triethylene glycol | 5% by mass |
| triethylene glycol-n-butyl ether | 2% by mass |
| Surfynol (tradename) 440 (*2) | 0.4% by mass |
| SUNNOL (trade name) NL1430 (*3) | 0.4% by mass |
| Water | balance |

(*1): Aqueous dispersion of C.I. Pigment Yellow 74 (average particle diameter 110 nm)
(*2) and (*3) are the same as those indicated in Table 1

### Evaluation Criteria for Red Chromaticness Evaluation

A: Chromaticness (C*) was not less than 58;
B: Chromaticness (C*) was not less than 56 and less than 58;
C: Chromaticness (C*) was less than 56.

### (c) Total Evaluation of Magenta Chromaticness and Red Chromaticness

The total (sum) of the chromaticness (C*) in (a) magenta chromaticness evaluation and the chromaticness (C*) in (b) red chromaticness evaluation was evaluated in accordance with the following evaluation criteria.

### Evaluation Criteria for Evaluation for Total of Magenta Chromaticness and Red Chromaticness

AA: The total (sum) was not less than 125;
A: The total (sum) was not less than 120 and less than 125;
C: The total (sum) was less than 120;
NG: Magenta color was not able to be produced or made.

### (d) Evaluation for Recording Density

The Optical density (OD value) of three portions in each of the evaluation samples in (b) red chromaticness evaluation was measured by using the spectrophotometric colorimetry meter SpectroEye (light source: D₅₀; field: 2°; ANSI-T). Then, an average value thereof was determined and the recording density was evaluated in accordance with the following evaluation criteria.

### Evaluation Criteria for Recording Density Evaluation

AA: The optical density (OD value) was not less than 1.26;
A: The optical density (OD value) was not less than 1.23 and less than 1.26;
B: The optical density (OD value) was not less than 1.19 and less than 1.23;
C: The optical density (OD value) was less than 1.19.

Table 1 indicates ink compositions and evaluation results in Examples 1 to 12 and Comparative Examples 1 and 2.

TABLE 1

| | | | Examples | | | | | | | | |
|---|---|---|---|---|---|---|---|---|---|---|---|
| | | | 1 | 2 | 3 | 4 | 5 | 6 | 7 | 8 | 9 |
| Ink | Quinacridone | Pigment dispersion | 2.4 | 3 | 3.6 | 4.2 | 4.8 | 5.4 | 5.7 | 2.8 | 3.15 |
| composition | pigment (Q) | liquid A (*4) | | | | | | | | | |
| (% by mass) | Azo | Pigment dispersion | 3.6 | 3 | 2.4 | 1.8 | 1.2 | 0.6 | 0.3 | 1.2 | 1.35 |
| | pigment (A) | liquid B (*5) | | | | | | | | | |
| | Humectant | Glycerol | 8 | 8 | 8 | 8 | 8 | 8 | 8 | 8 | 8 |
| | | Polyethylene | 3 | 3 | 3 | 3 | 3 | 3 | 3 | 3 | 3 |
| | | glycol #200 | | | | | | | | | |
| | | Triethylene | 5 | 5 | 5 | 5 | 5 | 5 | 5 | 5 | 5 |
| | | glycol | | | | | | | | | |
| | Penetrant | Triethylene | 2 | 2 | 2 | 2 | 2 | 2 | 2 | 2 | 2 |
| | | glycol-n-butyl | | | | | | | | | |
| | | ether | | | | | | | | | |
| | Surfactant | Surfynol | 0.4 | 0.4 | 0.4 | 0.4 | 0.4 | 0.4 | 0.4 | 0.4 | 0.4 |
| | | (tradename) | | | | | | | | | |
| | | 440 (*2) | | | | | | | | | |
| | | SUNNOL | 0.4 | 0.4 | 0.4 | 0.4 | 0.4 | 0.4 | 0.4 | 0.4 | 0.4 |
| | | (trade name) | | | | | | | | | |
| | | NL1430 (*3) | | | | | | | | | |

| | | | | | | | | | |
|---|---|---|---|---|---|---|---|---|---|
| Water | balance | balance | balance | balance | balance | balance | balance | balance | balance |

| | | | | | | | | | |
|---|---|---|---|---|---|---|---|---|---|
| Q:A | 40:60 | 50:50 | 60:40 | 70:30 | 80:20 | 90:10 | 95:5 | 70:30 | 70:30 |
| Q + A | 6 | 6 | 6 | 6 | 6 | 6 | 6 | 4 | 4.5 |
| Magenta chromaticness | B | A | AA | AA | AA | AA | AA | AA | AA |
| Red chromaticness | A | A | A | A | A | A | B | A | A |
| Total of magenta chromaticness | A | A | AA | AA | AA | A | A | A | A |
| and red chromaticness | | | | | | | | | |
| Recording density | AA | AA | AA | AA | AA | A | B | B | A |

| | | | | | | Comparative | |
|---|---|---|---|---|---|---|---|
| | | | Examples | | | Examples | |
| | | | 10 | 11 | 12 | 1 | 2 |
| Ink | Quinacridone | Pigment dispersion | 3.5 | 4.9 | 5.6 | 6 | — |
| composition | pigment (Q) | liquid A (*4) | | | | | |
| (% by mass) | Azo | Pigment dispersion | 1.5 | 2.1 | 2.4 | — | 6 |
| | pigment (A) | liquid B (*5) | | | | | |
| | Humectant | Glycerol | 8 | 8 | 8 | 8 | 8 |
| | | Polyethylene | 3 | 3 | 3 | 3 | 3 |
| | | glycol #200 | | | | | |
| | | Triethylene | 5 | 5 | 5 | 5 | 5 |
| | | glycol | | | | | |
| | Penetrant | Triethylene | 2 | 9 | 2 | 2 | 2 |
| | | glycol-n-butyl | | | | | |
| | | ether | | | | | |
| | Surfactant | Surfynol | 0.4 | 0.4 | 0.4 | 0.4 | 0.4 |
| | | (tradename) | | | | | |
| | | 440 (*2) | | | | | |
| | | SUNNOL | 0.4 | 0.4 | 0.4 | 0.4 | 0.4 |
| | | (trade name) | | | | | |
| | | NL1430 (*3) | | | | | |

| | | | | | |
|---|---|---|---|---|---|
| Water | balance | balance | balance | balance | balance |

| | | | | | |
|---|---|---|---|---|---|
| Q:A | 70:30 | 70:30 | 70:30 | 100:0 | 0:100 |
| Q + A | 5 | 7 | 8 | 6 | 6 |
| Magenta chromaticness | AA | AA | AA | AA | NG |
| Red chromaticness | A | A | A | A | A |
| Total of magenta chromaticness | AA | AA | AA | AA | NG |
| and red chromaticness | | | | | |
| Recording density | A | AA | AA | C | AA |

Table 1 (following) - LEGEND
(*4) Aqueous dispersion of solid solution (average particle diameter 120 nm) of PV19 and PR202; numerical values in Table 1 indicate the solid content amounts of pigment
(*5) Aqueous dispersion of PR150 (average particle diameter 110 nm); numerical values in Table 1 indicate the solid content amounts of pigment
(*2) Nonionic surfactant (acetylenic glycol-based surfactant) produced by Air Products and Chemicals, Inc; the numeric value in Table 1 indicates an active ingredient amount
(*3) Anionic surfactant produced by Lion Corporation; active ingredient 28% by weight; the numeric value in Table 1 indicates an active ingredient amount.

As indicated in Table Examples 1 to 12 had good evaluation results of the magenta chromaticness, the red chromaticness, the total of the magenta chromaticness and the red chromaticness, and the recording density. Namely, all the evaluation results were good. Since the evaluation results of the magenta chromaticness, the red chromaticness, and the total of the magenta chromaticness and the red chromaticness were good, it can be confirmed that, in each of Examples 1 to 12, in the area from magenta to red in the a*-b* plane, the color gamut of the image formed by using the water-based ink or the ink set was in a position where the chromaticness was high (a position away from the origin in the a*-b* plane). Namely, it can be confirmed that, in each of Examples 1 to 12, the chromaticness from magenta to red (the color gamut in the a*-b* planar direction) was wide.

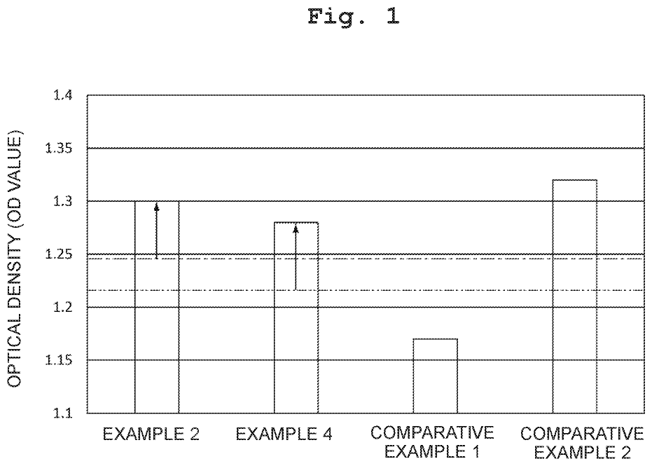

In each of Examples 1 to 12, the evaluation result of the recording density exceeded an intertnedi ate level that was an arithmetic average of PR150 (A) and the solid solution (Q) of PV19 and PR202. As indicated in FIG. 1, when Q:A=50:50 was satisfied, the intermediate level that was the arithmetic average was 1.17×0.5+1.32×0.5=1.245 (a dot-dash chain line in FIG. 1), which was obtained from the result (1.17) of Comparative Example 1 in which the solid solution of PV19 and PR202 was used alone and the result (1,32) of Comparative Example 2 in which PR150 was used alone. On the other hand, the result of Example 2 in which Q:A=50:50 was satisfied was 1.30, which greatly exceeded the intermediate level that was the arithmetic average, and the result of Example 2 showed synergistic effect. As indicated in FIG. 1, when Q:A=70:30 was satisfied, the intermediate level that was the arithmetic average was 1.17×0.7+1.32×0.3=1.215 (a chain double-dashed line in FIG. 1), which was obtained from the result (1.17) of Comparative Example 1 in which the solid solution of PV19 and PR202 was used alone and the result (1.32) of Comparative Example 2 in which PR150 was used alone. On the other hand, the result of Example 4 in which Q:A=70:30 was satisfied was 1.28, which greatly exceeded the intermediate level that was the arithmetic average, and the result of Example 4 showed synergistic effect. The reason why the synergistic effect appeared is assumed that intrinsic absorption peaks of PV19, PR202 and PR150 appropriately overlap. This mechanism, however, is just an assumption, and the present disclosure is not limited thereto.

In Examples 2 to 6 and 9 to 12 in which Q:A=90:10 to 50:50 was satisfied and Q+A was 4.5 to 8% by mass, the balance between the magenta chromaticness and the red chromaticness, or the recording density was better than Examples 1 and 7 in which Q:A=40:60 or Q:A=95:5 was satisfied and Example 8 in which Q+A was 4% by mass.

In Examples 3 to 5 and 10 to 12 in which Q:A=80:20 to 60:40 was satisfied and Q+A was 5 to 8% by mass, the evaluation result of the total of the magenta chromaticness and the red chromaticness was better than Example 2 in which Q:A=50:50 was satisfied and Example 9 in which Q+A was 4.5% by mass.

In Examples 3 to 5, 11 and 12 in which Q:A=80:20 to 60:40 was satisfied and Q+A was 6 to 8% by mass, the evaluation result of the recording density was better than Example 6 in which Q:A=90:10 was satisfied and Example 10 in which Q+A was 5% by mass.

In Comparative Example 1 in which no azo pigment was used, the evaluation result of the recording density was bad. In Comparative Example 2 in which no quinacridone pigment was used, the evaluation result of the magenta chromaticness was bad.

As described above, in the water-based ink of the present disclosure, the recording density (a color gamut in the L*-C* direction) is high (namely, the optical density is high) and the chrotnaticness from magenta to red (the color gamut in the a*-b* planar direction) is wide. The water-based ink of the present disclosure is widely applicable, for example, as the water-based magenta ink for ink-jet recording, to various kinds of ink-jet recording.

What is claimed is:

1. A water-based ink for ink-jet recording, comprising:
a solid solution of a quinacridone pigment including C.I. Pigment Violet 19 and C.I. Pigment Red 202,
an azo pigment including C.I. Pigment Red 150, and water.

2. The water-based ink for ink-jet recording according to claim 1, wherein a mass ratio (Q:A) of a content (Q) of the solid solution of the quinacridone pigment to a content (A) of the azo pigment in an entire amount of the water-based ink is in a range of 95:5 to 40:60, and
a total (Q+A) of the content (Q) of the solid solution of the quinacridone pigment and the content (A) of the azo pigment in the entire amount of the water-based ink is in a range of 4 to 8% by mass.

3. The water-based ink for ink-jet recording according to claim 2, wherein the mass ratio (Q:A) of the content (Q) of the solid solution of the quinacridone pigment to the content (A) of the azo pigment in the entire amount of the water-based ink is in a range of 90:10 to 50:50, and
the total (Q+A) of the content (Q) of the solid solution of the quinacridone pigment and the content (A) of the azo pigment in the entire amount of the water-based ink is in a range of 4.5 to 8% by mass.

4. The water-based ink for ink-jet recording according to claim 3, wherein the mass ratio (Q:A) of the content (Q) of the solid solution of the quinacridone pigment to the content (A) of the azo pigment in the entire amount of the water-based ink is in a range of 80:20 to 60:40, and
the total (Q+A) of the content (Q) of the solid solution of the quinacridone pigment and the content (A) of the azo pigment in the entire amount of the water-based ink is in a range of 5 to 8% by mass.

5. The water-based ink for ink-jet recording according to claim 4, wherein the mass ratio (Q:A) of the content (Q) of the solid solution of the quinacridone pigment to the content (A) of the azo pigment in the entire amount of the water-based ink is in a range of 80:20 to 60:40, and
the total (Q+A) of the content (Q) of the solid solution of the quinacridone pigment and the content (A) of the azo pigment in the entire amount of the water-based ink is in a range of 6 to 8% by mass.

6. The water-based ink for ink-jet recording according to claim 1, further comprising an acetylenic glycol-based surfactant,
wherein a ratio of a content of the acetylenic glycol-based surfactant to a total of 100 parts by mass of a content of the solid solution of the quinacridone pigment and a content of the azo pigment is not less than 4 parts by mass.

7. The water-based ink for ink-jet recording according to claim 1, further comprising a quinacridone pigment which is different from the solid solution.

8. An ink set comprising:
a water-based magenta ink for ink-jet recording that is the water-based ink for ink-jet recording described in claim 1; and
a water-based yellow ink for ink-jet recording that contains a yellow pigment and water.

9. The ink set according to claim 8, further satisfying the following conditional expression:
Y≤(Q+A)+2
wherein in the conditional expression,
Y: a content of the yellow pigment in an entire amount of the water-based yellow ink (% by mass); and
Q+A: a total (% by mass) of a content (Q) of the solid solution of the quinacridone pigment and a content (A) of the azo pigment in an entire amount of the water-based magenta ink.

10. The ink set according to claim 8, wherein the yellow pigment is C.I. Pigment Yellow 74.
